(19) United States
(12) Patent Application Publication
(10) Pub. No.: US 2016/0080771 A1
(43) Pub. Date: Mar. 17, 2016

(54) MOTION COMPENSATION APPARATUS HAVING AT LEAST ONE PROCESSING CIRCUIT SHARED BY NORMAL MODE AND RESIZED REFERENCE FRAME MODE AND RELATED MOTION COMPENSATION METHOD

(71) Applicant: MEDIATEK INC., Hsin-Chu (TW)

(72) Inventors: Chun-Chia Chen, Hsinchu City (TW); Yung-Chang Chang, New Taipei City (TW)

(21) Appl. No.: 14/845,282

(22) Filed: Sep. 4, 2015

Related U.S. Application Data
(60) Provisional application No. 62/051,332, filed on Sep. 17, 2014.

(51) Int. Cl. H04N 19/573; H04N 19/80; H04N 19/182

(52) U.S. Cl. CPC H04N 19/573; H04N 19/182; H04N 19/80

(57) ABSTRACT

A motion compensation apparatus includes an interpolation filter device, a pixel fetching circuit, and a pixel dispatching circuit. The interpolation filter device generates interpolated pixels by performing interpolation according to reference pixels. The pixel fetching circuit fetches the reference pixels from a reference frame. The pixel dispatching circuit dispatches pixels to the interpolation filter device, wherein the pixels comprise the reference pixels. At least one of the interpolation filter device, the pixel fetching circuit and the pixel dispatching circuit is shared by a normal mode and a resized reference frame (RRF) mode of motion compensation.

### CROSS REFERENCE TO RELATED APPLICATIONS

This application claims the benefit of U.S. provisional application No. 62/051,332, filed on Sep. 17, 2014 and incorporated herein by reference.

### BACKGROUND

The present invention relates to video processing, and more particularly, to a motion compensation apparatus having at least one processing circuit shared by a normal mode and a resized reference frame mode and a related motion compensation method.

Successive video frames may contain the same objects (still objects or moving objects). Motion estimation can examine the movement of objects in a video sequence composed of successive video frames to try to obtain vectors representing the estimated motion. Motion compensation can use the knowledge of object motion obtained by motion estimation to achieve frame data compression/decompression. In inter-frame coding, motion estimation and motion compensation have become powerful techniques to eliminate the temporal redundancy due to high correlation between consecutive video frames.

With regard to a typical coding algorithm, a frame dimension of a current frame is the same as a frame dimension of a reference frame (e.g., a reconstructed frame at the encoder side or a decoded frame at the decoder side). That is, the current frame and the reference frame have the same width and the same height. Hence, a motion vector of a current block in the current frame can be directly used to locate a reference block in the reference block for motion compensation. However, with regard to a newly-developed coding algorithm, it may allow the frame resolution to be changed on-the-fly. Hence, the reference frame may be resized to have a resolution different from a resolution of the current frame. Due to discrepancy between frame dimensions of the current frame and the resized reference frame, a motion vector of a current block in the current frame cannot be directly used to locate a reference block in the resized reference frame for motion compensation. A resizing filter may be needed to make a reference block in the resized reference frame changed to the scale of the current frame.

Using two separate motion compensators, one for a normal mode and the other for a resized reference frame mode, is not cost-effective. Thus, there is a need for an innovative motion compensation design which is capable of supporting the normal mode and the resized reference frame mode of motion compensation with reduced production cost.

### SUMMARY

One of the objectives of the claimed invention is to provide a motion compensation apparatus having at least one processing circuit shared by a normal mode and a resized reference frame mode and a related motion compensation method.

According to a first aspect of the present invention, an exemplary motion compensation apparatus is disclosed. The exemplary motion compensation apparatus includes an interpolation filter device, a pixel fetching circuit, and a pixel dispatching circuit. The interpolation filter device is arranged to generate interpolated pixels by performing interpolation according to reference pixels. The pixel fetching circuit is arranged to fetch the reference pixels from a reference frame. The pixel dispatching circuit is arranged to dispatch pixels to the interpolation filter device, wherein the pixels comprise the reference pixels. At least one of the interpolation filter device, the pixel fetching circuit and the pixel dispatching circuit is shared by a normal mode and a resized reference frame (or called resolution reference frame) (RRF) mode of motion compensation.

According to a second aspect of the present invention, an exemplary motion compensation method is disclosed. The exemplary motion compensation method includes: utilizing an interpolation filter device to generate interpolated pixels by performing interpolation according to reference pixels; utilizing a pixel fetching circuit to fetch the reference pixels from a reference frame; utilizing a pixel dispatching circuit to dispatch pixels to the interpolation filter device, wherein the pixels comprise the reference pixels; and sharing at least one of the interpolation filter device, the pixel fetching circuit and the pixel dispatching circuit by a normal mode and a resized reference frame (RRF) mode of motion compensation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a motion compensation apparatus according to an embodiment of the present invention.

FIG. 2 is a diagram illustrating a fractional-pel interpolation filter according to an embodiment of the present invention.

FIG. 3 is a diagram illustrating the behavior of RRF-mode motion compensation according to an embodiment of the present invention.

FIG. 4 is a diagram illustrating the behavior of fractional-pel interpolation in the RRF mode according to an embodiment of the present invention.

FIG. 5 is a diagram illustrating one exemplary implementation of a pixel dispatching circuit and an interpolation filter device shown in FIG. 1.

FIG. 6 is a flowchart illustrating a motion compensation method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

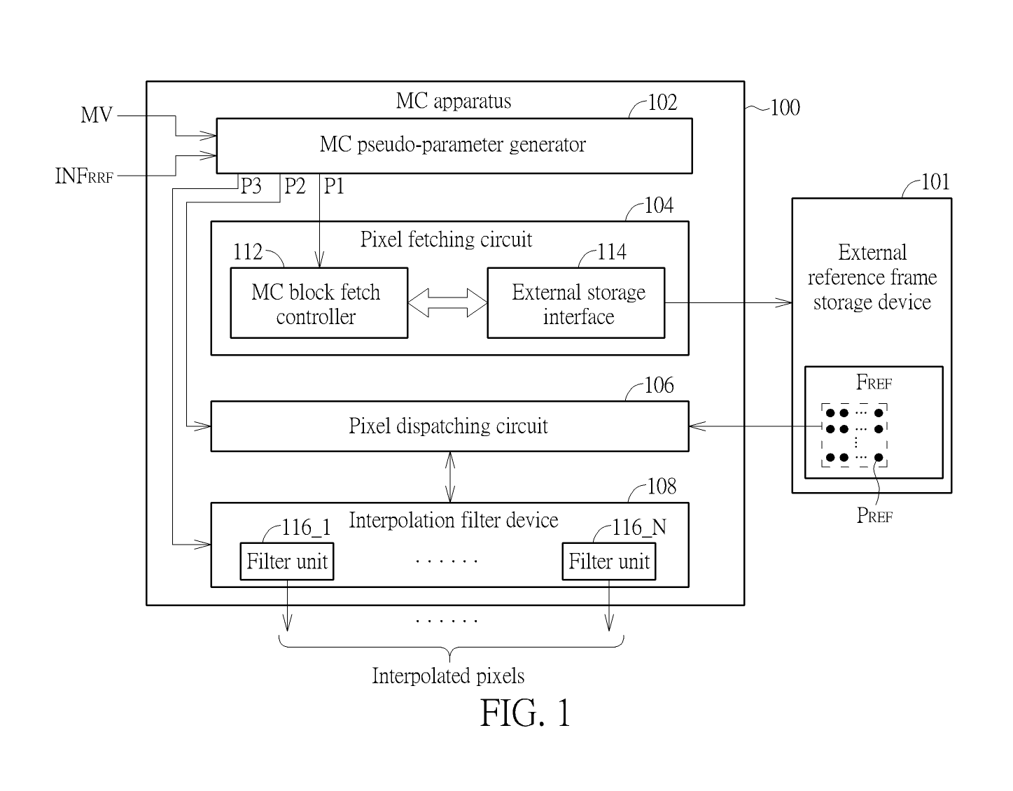

FIG. 1 is a block diagram illustrating a motion compensation apparatus according to an embodiment of the present invention. In one application, the motion compensation apparatus 100 may be part of a video encoder used to perform a video encoding procedure compliant with a video coding standard such as VP9 or SVC (Scalable Video Coding). In another application, the motion compensation apparatus 100 may be part of a video decoder used to perform a video decoding procedure compliant with a video coding standard such as VP9 or SVC. In accordance with the VP9/SVC video coding standard, the reference frame resizing feature is a technique which allows a frame size to change on-the-fly inside a video bitstream. Hence, there may be a discrepancy between frame dimensions of a current frame (e.g., a video frame currently being encoded at the encoder side or a video frame currently being decoded at the decoder side) and a reference frame (e.g., a resized reconstructed frame serving as a reference frame at the encoder side or a resized reconstructed frame serving as a reference frame at the decoder side). The proposed motion compensation apparatus 100 is capable of supporting a normal mode and a resized reference frame (or called resolution reference frame) (RRF) mode of motion compensation with reduced production cost. For example, the motion compensation apparatus 100 may be configured to have at least one processing circuit shared by the normal mode and the RRF mode of motion compensation. In other words, at least a portion (i.e., part or all) of the motion compensation apparatus 100 may be involved in both of normal-mode motion compensation and RRF-mode motion compensation when the proposed hardware sharing technique is employed.

As shown in FIG. 1, the motion compensation (MC) apparatus 100 includes a motion compensation pseudo-parameter generator 102, a pixel fetching circuit 104, a pixel dispatching circuit 106, and an interpolation filter device 108. The motion compensation pseudo-parameter generator 102 is arranged to set motion compensation pseudo-parameters used to control operations of the interpolation filter device 108, the pixel fetching circuit 104 and the pixel dispatching circuit 106 in the RRF mode. For example, the pixel fetching circuit 104 is responsive to a motion compensation pseudo-parameter set P1 generated from the motion compensation pseudo-parameter generator 102, the pixel dispatching circuit 106 is responsive to a motion compensation pseudo-parameter set P2 generated from the motion compensation pseudo-parameter generator 102, and the interpolation filter device 108 is responsive to a motion compensation pseudo-parameter set P3 generated from the motion compensation pseudo-parameter generator 102. In this embodiment, the motion compensation pseudo-parameter generator 102 receives a motion vector and resizing information INF_{RRF} to generate the motion compensation pseudo-parameters.

The pixel fetching circuit 104 is arranged to fetch reference pixels P_{REF} from a reference frame F_{REF} stored in an external reference frame storage device 101. For example, the external reference frame storage device 101 may be a dynamic random access memory (DRAM). In this embodiment, the pixel fetching circuit 104 includes a motion compensation block fetch controller 112 and an external storage interface 114. For example, the external storage interface 114 may be a memory interface such as a direct memory access (DMA) interface. The motion block fetch controller 112 may refer to information given in the motion compensation pseudo-parameter set P1 to generate fetch commands to the external reference frame storage device 101 via the external storage interface 114, where the fetch commands are used to fetch the reference pixels P_{REF} needed to determine interpolated pixels for motion compensation of a current block in a current frame.

The pixel dispatching circuit 106 is arranged to dispatch pixels to the interpolation filter device 108, wherein the pixels include the reference pixels P_{REF} read from the external reference frame storage device 101 under the control of the pixel fetching circuit 104. The interpolation filter device 108 is arranged to generate the interpolated pixels by performing interpolation (e.g., fractional-pel interpolation) according to the reference pixels P_{REF}. For example, the interpolation filter device 108 may have filter units 116_1-116_N, where N is a positive integer. Each of the filter units 116_1-116_N may have a horizontal filter and a vertical filter. In one exemplary embodiment, a portion of reference pixels P_{REF} may be processed by a horizontal filter of one filter unit to generate a filtered pixel, and then a plurality of filtered pixels successively generated from the horizontal filter may be processed by a vertical filter in the same filter unit to generate one interpolated pixel. In another exemplary embodiment, a portion of reference pixels P_{REF} may be processed by a vertical filter of one filter unit to generate a filtered pixel, and then a plurality of filtered pixels successively generated from the vertical filter may be processed by a horizontal filter in the same filter unit to generate one interpolated pixel. That is, the order of horizontal-direction interpolation and vertical-direction interpolation performed in one filter unit depends on the actual design consideration.

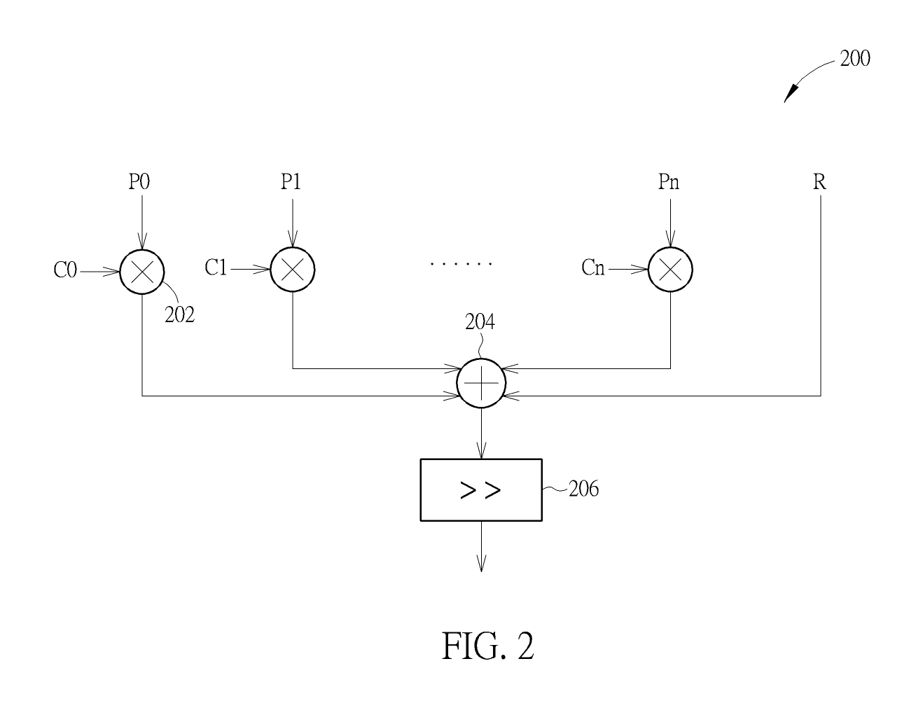

FIG. 2 is a diagram illustrating a fractional-pel interpolation filter according to an embodiment of the present invention. The fractional-pel interpolation filter 200 includes a plurality of multipliers 202, an adder 204 and a right-shift circuit 206. The fractional-pel interpolation may be expressed using the following formula:

(C0*P0+C1*P1+ . . . +Cn*Pn+R)>>S,

where P0-Pn represent input pixels, C0-Cn represent filter coefficients, R represents a rounding value, and S represents a right-shifted bit number. Each vertical filter and each horizontal filter included in the interpolation filter device 108 may be implemented using the fractional-pel interpolation filter 200. In one case where the fractional-pel interpolation filter 200 is used as a horizontal filter, P0-Pn may represent input pixels located at the same row or may represent fractional pixels of the same vertical position. In another case where the fractional-pel interpolation filter 200 is used as a vertical filter, P0-Pn may represent input pixels located at the same column or may represent fractional pixels of the same horizontal position. The filter coefficients C0-Cn of the horizontal filter and the vertical filter should be properly set for obtaining the correct interpolated pixel.

In this embodiment, the motion compensation apparatus 100 employs a hardware sharing technique. Hence, at least one of the interpolation filter device 108, the pixel fetching circuit 104 and the pixel dispatching circuit 106 is shared by a normal mode and a resized reference frame (RRF) mode of motion compensation. When a current frame size is equal to a reference frame size, the normal mode is enabled. As a person skilled in the art should readily understand details of the normal-mode motion compensation, further description is omitted here for brevity. However, when a current frame size is different from a reference frame size, the RRF mode is enabled. More specifically, at least a portion (i.e., part or all) of the existing motion compensation hardware used by the normal mode to determine interpolated pixels for motion compensation may be re-used by the RRF mode to determine interpolated pixels for motion compensation. For example, the normal-mode motion compensation may be performed by using pixel fetching circuit 104, pixel dispatching circuit 106 and interpolation filter device 108, and RRF-mode motion compensation may be performed by re-using pixel fetching circuit 104, pixel dispatching circuit 106 and interpolation filter device 108.

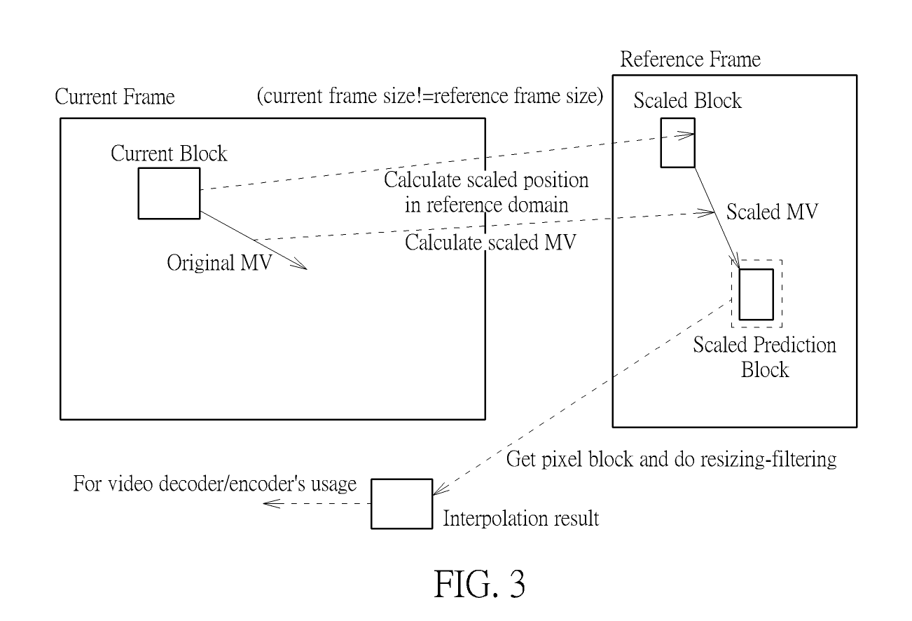

FIG. 3 is a diagram illustrating the behavior of RRF-mode motion compensation according to an embodiment of the present invention. Since the current frame size is different from the reference frame size, a scaled prediction block in the reference frame (which is determined by a scaled motion vector and a scaled block in the reference frame) is used as a motion-compensated block for the current block. However, it is possible that the scaled prediction block is not located at an integer-pel location (i.e., the scaled prediction block is not composed of integer-position pixels in the reference frame). Hence, fractional-pel interpolation is needed to determine interpolated pixels (i.e., fractional-position pixels) of the scaled prediction block.

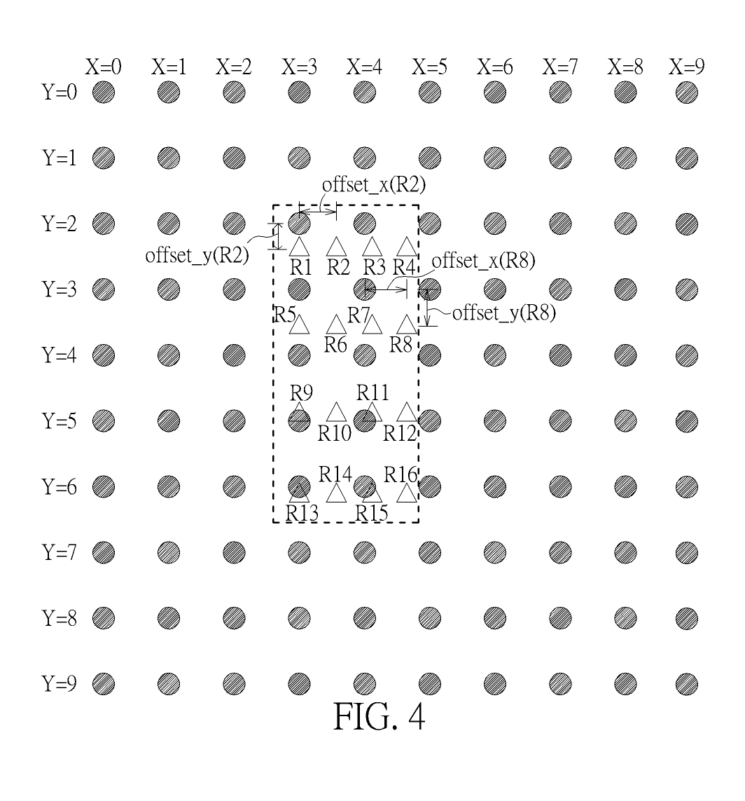

FIG. 4 is a diagram illustrating the behavior of fractional-pel interpolation in the RRF mode according to an embodiment of the present invention. The scaled prediction block BK_{SP} is not located at an integer-pel location, and is composed of fractional-position pixels R1-R16. The fractional-position pixels R1-R16 do not have a constant horizontal fraction offset with respect to integer-position pixels and a constant vertical fraction offset with respect to integer-position pixels due to discrepancy between the current frame size and the reference frame size. For example, the horizontal fraction offset offset_x(R2) of the fractional-position pixel R2 is different from the horizontal fraction offset offset_x(R8), and the vertical fraction offset offset_y(R2) of the fractional-position pixel R2 is different from the vertical fraction offset offset_y(R8). As can be seen from FIG. 4, fractional-position pixels R1-R16 have irregular horizontal fraction offsets and irregular vertical fraction offsets. Hence, filter coefficients used by each of the filter units 116_1-116_N (e.g., N=4) are not necessarily the same. In a case where the horizontal interpolation is performed before the vertical interpolation, filter coefficients used by a horizontal filter in one of the filter units 116_1-116_N (e.g., N=4) may be different from filter coefficients used by a horizontal filter in another of the filter units 116_1-116_N (e.g., N=4). In another case where the vertical interpolation is performed before the horizontal interpolation, filter coefficients used by a vertical filter in one of the filter units 116_1-116_N (e.g., N=4) may be different from filter coefficients used by a vertical filter in another of the filter units 116_1-116_N (e.g., N=4).

Further, since the fractional-position pixels R1-R16 have irregular horizontal fraction offsets and irregular vertical fraction offsets, input pixels fed into the filter units 116_1-116_N (e.g., N=4) are not necessarily different from one another. For example, input pixels fed into a horizontal filter in one of the filter units 116_1-116_N (e.g., N=4) may be the same as input pixels fed into a horizontal filter in another of the filter units 116_1-116_N (e.g., N=4). For another example, input pixels fed into a vertical filter in one of the filter units 116_1-116_N (e.g., N=4) may be the same as input pixels fed into a vertical filter in another of the filter units 116_1-116_N (e.g., N=4). Consider a case where each filter unit is configured to perform the horizontal interpolation and the vertical interpolation in order, six reference pixels located at X=1˜6 are dispatched to a first filter unit responsible for generating the fractional-position pixel R1, where filter coefficients of the first filter unit may be set based on the horizontal fraction offset offset_x(R1) and the vertical fraction offset offset_y(R1); six reference pixels located at X=1˜6 are dispatched to a second filter unit responsible for generating the fractional-position pixel R2, where filter coefficients of the second filter unit may be set based on the horizontal fraction offset offset_x(R2) and the vertical fraction offset offset_y(R2); six reference pixels located at X=2˜7 are dispatched to a third filter unit responsible for generating the fractional-position pixel R3, where filter coefficients of the third filter unit may be set based on the horizontal fraction offset offset_x(R3) and the vertical fraction offset offset_y(R3); and six reference pixels located at X=2˜7 are dispatched to a fourth filter unit responsible for generating the fractional-position pixel R4, where filter coefficients of the fourth filter unit may be set based on the horizontal fraction offset offset_x(R4) and the vertical fraction offset offset_y(R4). In this example, horizontal fraction offsets offset_x(R1)-offset_x(R4) may be different from one another, while vertical fraction offsets offset_y(R1)-offset_y(R4) may be the same. However, this is for illustrative purposes only, and is not meant to be a limitation of the present invention.

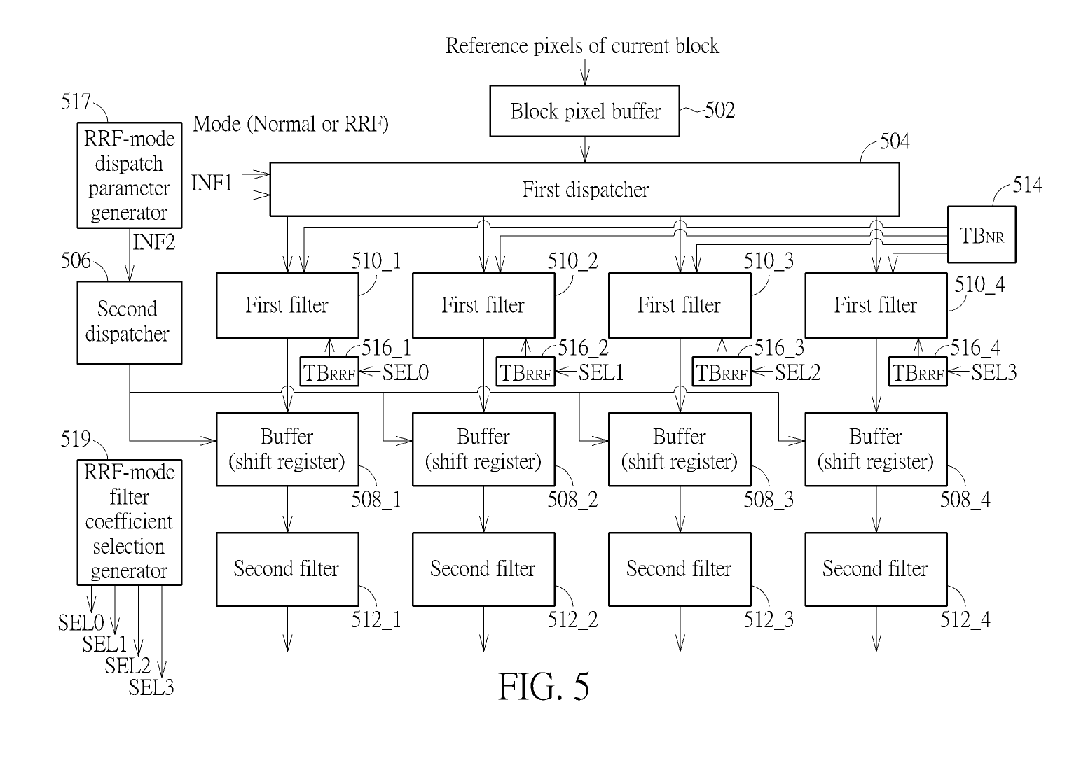

In this embodiment, at least one of the interpolation filter device 108, the pixel fetching circuit 104 and the pixel dispatching circuit 106 is shared by a normal mode and an RRF mode of motion compensation. As mentioned above, the normal-mode motion compensation and the RRF-mode motion compensation may require different parameter settings. Hence, each shared processing circuit in the motion compensation apparatus 100 should be properly configured to support the normal-mode motion compensation and the RRF-mode motion compensation. Please refer to FIG. 1 in conjunction with FIG. 5. FIG. 5 is a diagram illustrating one exemplary implementation of the pixel dispatching circuit 106 and the interpolation filter device 108 shown in FIG. 1. The pixel dispatching circuit 106 in FIG. 1 may include a first dispatcher 504, a second dispatcher 506, and a plurality of buffers 508_1-508_N (e.g., N=4). The interpolation filter device 108 in FIG. 1 may include a plurality of first filters 510_1-510_N (e.g., N=4), a plurality of second buffers 512_1-512_N (e.g., N=4), a normal-mode filter coefficient table (denoted as “TB_{NR}”) 514, a plurality of RRF-mode filter coefficient tables (denoted as “TB_{RRF}”) 516_1-516_N (e.g., N=4), where a combination of one first filter and one second filter connected in series may form one filter unit. For example, the filter unit 116_1 in FIG. 1 may include the first filter 510_1 and the second filter 512_1.

In addition, the motion pseudo-parameter generator 102 in FIG. 1 may include an RRF-mode dispatch parameter generator 517 and an RRF-mode filter coefficient selection generator 519. The RRF-mode dispatch parameter generator 517 is arranged to generate one pseudo-parameter set P2, including first dispatching information INF1 and second dispatching information INF2, to the pixel dispatching circuit 106, where the first dispatching information INF1 is supplied to the first dispatcher 504, and the second dispatching information INF2 is supplied to the second dispatcher 506. The RRF-mode filter coefficient selection generator 519 is arranged to generate one pseudo-parameter set P3, including a plurality of selection signals (e.g., Sel0-Sel3) supplied to the RRF-mode filter coefficient tables (e.g., 516_1-516_4), respectively, wherein each selection signal is used to select a set of filter coefficients from the corresponding RRF-mode filter coefficient table.

In a first exemplary embodiment, the pixel fetching circuit 104 may be configured to be shared by the normal mode (current frame size=reference frame size) and the RRF-mode (current frame size≠reference frame size). Hence, regarding the same current block in the current frame, integer-position reference pixels of the current block fetched from the external reference frame storage device 101 for fractional-pel interpolation in the RRF mode may be different from integer-position reference pixels of the current block fetched from the external reference frame storage device 101 for fractional-pel interpolation in the normal mode. The motion compensation pseudo-parameter generator 102 is arranged to receive a motion vector MV and resizing information INF_{RRF} from a preceding processing circuit (e.g., a variable-length decoding (VLD) circuit when the motion compensation apparatus 100 is part of a video decoder), and generate the pseudo-parameter set P1 to the pixel fetching circuit 104. For example, the resizing information INF_{RRF} may include a block size of the current block, a block position of the current block, a frame size of the current frame, a frame size of the reference frame, etc. The motion compensation pseudo-parameter generator 102 may refer to the motion vector MV and the resizing information INF_{RRF} to determine a scaled prediction block start X coordinate and a scaled prediction block start Y coordinate, and then determine the integer-position reference pixels required by the fractional-pel interpolation used to generate interpolated pixels of a motion-compensated block for the current block.

In a second exemplary embodiment, the pixel dispatching circuit 106 may be configured to be shared by the normal mode (current frame size=reference frame size) and the RRF-mode (current frame size≠reference frame size). For example, one or both of the first dispatcher 504 and the second dispatcher 506 may be shared by the normal mode and the RRF mode. As shown in FIG. 5, a block pixel buffer 502 may be used to temporarily store integer-position reference pixels of the current block fetched from the external reference frame storage device 101. In a case where the first filters 510_1-510_N (e.g., N=4) are horizontal filters and the second filters 512_1-512_N (e.g., N=4) are vertical filters, the first dispatcher 504 is a horizontal dispatcher and the second dispatcher 506 is a vertical dispatcher. In another case where the first filters 510_1-510_N (e.g., N=4) are vertical filters and the second filters 512_1-512_N (e.g., N=4) are horizontal filters, the first dispatcher 504 is a vertical dispatcher and the second dispatcher 506 is a horizontal dispatcher.

The first dispatcher 504 is arranged to dispatch reference pixels read from the block pixel buffer 502 to the first filters 510_1-510_N (e.g., N=4) according to the dispatching information INF1, such that each first filter uses dispatched reference pixels as its input pixels and generates one filtered pixel correspondingly. The buffers 508_1-508_N (e.g., N=4) are used to buffer the filtered pixels generated from the first filters 510_1-510_N (e.g., N=4). For example, the buffers 508_1-508_N (e.g., N=4) may be implemented using shift registers. The second dispatcher 506 is arranged to control each of the buffers 508_1-508_N (e.g., N=4) for dispatching filtered pixels generated from a preceding first filter to a following second filter according to the dispatching information INF2, such that each second filter uses dispatched filtered pixels as its input pixels and generates one interpolated pixel correspondingly. It should be noted that, due to the irregular fraction offsets in the RRF mode, two interpolated pixels may be successively generated from the same second filter according to the same input pixels (i.e., the same filtered pixels generated from the preceding first filter). Hence, the second dispatcher 506 may properly control the buffer (e.g., shift register) to output the same filtered pixels more than once.

The motion compensation pseudo-parameter generator 102 is arranged to receive the motion vector MV and the resizing information INF_{RRF} from a preceding processing circuit (e.g., a VLD circuit when the motion compensation apparatus 100 is part of a video decoder), and generate the pseudo-parameter set P2 to the pixel dispatching circuit 106. For example, the resizing information INF_{RRF} may include a block size of the current block, a block position of the current block, a frame size of the current frame, a frame size of the reference frame, etc. The motion compensation pseudo-parameter generator 102 refers to the motion vector MV and the resizing information INF_{RRF} to determine a scaled prediction block start X coordinate and a scaled prediction block start Y coordinate, and then determine the reference pixels required by each first filter and filtered pixels required by each second filter and set the first dispatching information INF1 and second dispatching information INF2.

In a third exemplary embodiment, the interpolation filter device 108 may be configured to be shared by the normal mode (current frame size=reference frame size) and the RRF-mode (current frame size reference frame size). Hence, the first filters 510_1-510_N (e.g., N=4) and/or the second filters 5121-512N (e.g., N=4) may be shared by the normal mode and the RRF mode. For example, the first filters 510_1-510_N (e.g., N=4) are horizontal filters, and the second filters 512_1-512_N (e.g., N=4) are vertical filters. For another example, the first filters 510_1-510_N (e.g., N=4) are vertical filters, and the second filters 512_1-512_N (e.g., N=4) are horizontal filters. As shown in FIG. 5, RRF-mode filter coefficient tables 516_1-516_N (e.g., N=4) are coupled to the first filters (e.g., horizontal filters or vertical filters) 510_1-510_N (e.g., N=4), respectively. As mentioned above, fractional-position pixels (i.e., interpolated pixels) have irregular horizontal fraction offsets and irregular vertical fraction offsets. Hence, in the RRF mode, each of the RRF-mode filter coefficient tables 516_1-516_N (e.g., N=4) is properly controlled to select a set of filter coefficients for a corresponding first filter, such that each first filter uses the selected filter coefficients to generate one filtered pixel.

The motion compensation pseudo-parameter generator 102 is arranged to receive the motion vector MV and the resizing information INF_{RRF} from a preceding processing circuit (e.g., a VLD circuit when the motion compensation apparatus 100 is part of a video decoder), and generate the pseudo-parameter set P3 to the interpolation filter device 108. For example, the resizing information INF_{RRF} may include a block size of the current block, a block position of the current block, a frame size of the current frame, a frame size of the reference frame, etc. The motion compensation pseudo-parameter generator 102 refers to the motion vector MV and the resizing information INF_{RRF} to determine a scaled prediction block start X coordinate and a scaled prediction block start Y coordinate, and then determine the filter coefficients required by each first filter and each second filter. For example, to generate interpolated pixels, the first filters 510_1-510_N (e.g., N=4) may be configured to use different filter coefficient settings, and the second filters 512_1-512_N (e.g., N=4) may be configured to use the same filter coefficient setting. However, this is for illustrative purposes only, and is not meant to be a limitation of the present invention.

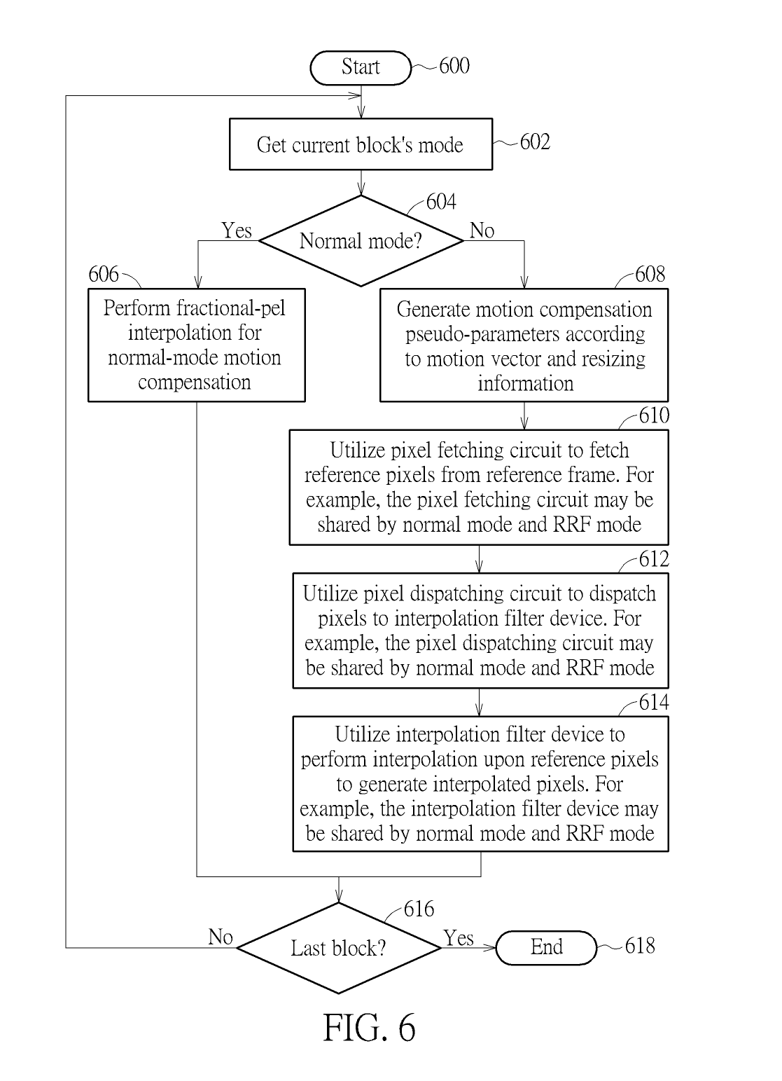

FIG. 6 is a flowchart illustrating a motion compensation method according to an embodiment of the present invention. Provided that the result is substantially the same, the steps are not required to be executed in the exact order shown in FIG. 6. In addition, one or more steps may be added to or removed from the flow shown in FIG. 6. The motion compensation method may be employed by the motion compensation apparatus 100 shown in FIG. 1, and may be briefly summarized as below.

Step 600: Start.

Step 602: Get current block's mode.

Step 604: Check if motion compensation should be performed in a normal mode. If yes, go to step 606; otherwise, go to step 608.

Step 606: Perform fractional-pel interpolation for normal-mode motion compensation. Go to step 616.

Step 608: Generate motion compensation pseudo-parameters according to a motion vector and resizing information.

Step 610: Utilize a pixel fetching circuit to fetch reference pixels from a reference frame. The pixel fetching circuit may be shared by the normal mode and the RRF mode, and may fetch the reference pixels according to one pseudo-parameter set.

Step 612: Utilize a pixel dispatching circuit to dispatch pixels to an interpolation filter device, wherein the pixels comprise the reference pixels. The pixel dispatching circuit may be shared by the normal mode and the RRF mode, and may dispatch the pixels to the interpolation filter device according to one pseudo-parameter set.

Step 614: Utilize the interpolation filter device to perform interpolation upon the reference pixels to generate interpolated pixels. The interpolation filter device may be shared by the normal mode and the RRF mode, and may perform fractional-pel interpolation for RRF-mode motion compensation according to one pseudo-parameter set.

Step 616: Check if motion compensation for a last block is done. If yes, go to step 618; otherwise, go to step 602 to perform motion compensation for another block.

Step 618: End.

As a person skilled in the art can readily understand details of each step shown in FIG. 6 after reading above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion compensation apparatus comprising:
an interpolation filter device, arranged to generate interpolated pixels by performing interpolation according to reference pixels;
a pixel fetching circuit, arranged to fetch the reference pixels from a reference frame; and
a pixel dispatching circuit, arranged to dispatch pixels to the interpolation filter device, wherein the pixels comprise the reference pixels;
wherein at least one of the interpolation filter device, the pixel fetching circuit and the pixel dispatching circuit is shared by a normal mode and a resized reference frame (RRF) mode of motion compensation.

2. The motion compensation apparatus of claim 1, wherein the interpolation filter device comprises a plurality of horizontal filters shared by the normal mode and the RRF mode.

3. The motion compensation apparatus of claim 2, wherein the interpolation filter device further comprises:
a plurality of RRF-mode filter coefficient tables, coupled to the horizontal filters, respectively; and
an RRF-mode filter coefficient selection generator, arranged to generate a plurality of selection signals to the RRF-mode filter coefficient tables, respectively, wherein filter coefficients used by each horizontal filter in the RRF mode is selected from a corresponding RRF-mode filter coefficient table in response to a corresponding selection signal.

4. The motion compensation apparatus of claim 1, wherein the interpolation filter device comprises a plurality of vertical filters shared by the normal mode and the RRF mode.

5. The motion compensation apparatus of claim 4, wherein the interpolation filter device further comprises:
a plurality of RRF-mode filter coefficient tables, coupled to the vertical filters, respectively; and
an RRF-mode filter coefficient selection generator, arranged to generate a plurality of selection signals to the RRF-mode filter coefficient tables, respectively, wherein filter coefficients used by each vertical filter in the RRF mode is selected from a corresponding RRF-mode filter coefficient table in response to a corresponding selection signal.

6. The motion compensation apparatus of claim 1, wherein the pixel dispatching circuit comprises a dispatcher shared by the normal mode and the RRF mode and arranged to dispatch the reference pixels to a plurality of filters included in the interpolation filter device, and the filters are arranged to perform interpolation in a same direction.

7. The motion compensation apparatus of claim 1, wherein the pixel dispatching circuit comprises:
a plurality of buffers, each coupled between a first filter and a second filter included in the interpolation filter device; and
a dispatcher, shared by the normal mode and the RRF mode and arranged to control the buffers to dispatch filtered pixels generated from a plurality of first filters included in the interpolation filter device to a plurality of second filters included in the interpolation filter device, respectively, wherein the first filters are arranged to perform interpolation in a same first direction, and the second filters are arranged to perform interpolation in a same second direction different from the first direction.

8. The motion compensation apparatus of claim 1, wherein the pixel fetching circuit is shared by the normal mode and the RRF mode.

9. The motion compensation apparatus of claim 1, further comprising:
a motion compensation pseudo-parameter generator, arranged to control operations of the interpolation filter device, the pixel fetching circuit and the pixel dispatching circuit in the RRF mode.

10. The motion compensation apparatus of claim 9, wherein the motion compensation pseudo-parameter generator is arranged to receive a motion vector and resizing-related information to generate motion compensation pseudo-parameters to the interpolation filter device, the pixel fetching circuit and the pixel dispatching circuit in the RRF mode.

11. A motion compensation method comprising:
utilizing an interpolation filter device to generate interpolated pixels by performing interpolation according to reference pixels;
utilizing a pixel fetching circuit to fetch the reference pixels from a reference frame; and
utilizing a pixel dispatching circuit to dispatch pixels to the interpolation filter device, wherein the pixels comprise the reference pixels;
sharing at least one of the interpolation filter device, the pixel fetching circuit and the pixel dispatching circuit by a normal mode and a resized reference frame (RRF) mode of motion compensation.

12. The motion compensation method of claim 11, wherein sharing at least one of the interpolation filter device, the pixel fetching circuit and the pixel dispatching circuit comprises:
sharing a plurality of horizontal filters included in the interpolation filter device by the normal mode and the RRF mode.

13. The motion compensation method of claim 12, wherein sharing the horizontal filters included in the interpolation filter device by the normal mode and the RRF mode comprises:
generating a plurality of selection signals to a plurality of RRF-mode filter coefficient tables, respectively;
wherein the RRF-mode filter coefficient tables are coupled to the horizontal filters, respectively; and filter coefficients used by each horizontal filter in the RRF mode is selected from a corresponding RRF-mode filter coefficient table in response to a corresponding selection signal.

14. The motion compensation method of claim 11, wherein sharing at least one of the interpolation filter device, the pixel fetching circuit and the pixel dispatching circuit comprises:
sharing a plurality of vertical filters included in the interpolation filter device by the normal mode and the RRF mode.

15. The motion compensation method of claim 14, wherein sharing the vertical filters included in the interpolation filter device by the normal mode and the RRF mode comprises:
generating a plurality of selection signals to a plurality of RRF-mode filter coefficient tables, respectively;
wherein the RRF-mode filter coefficient tables are coupled to the vertical filters, respectively; and filter coefficients used by each vertical filter in the RRF mode is selected from a corresponding RRF-mode filter coefficient table in response to a corresponding selection signal.

16. The motion compensation method of claim 11, wherein sharing at least one of the interpolation filter device, the pixel fetching circuit and the pixel dispatching circuit comprises:
sharing a dispatcher included in the pixel dispatching circuit by the normal mode and the RRF mode; and
utilizing the dispatcher for dispatching the reference pixels to a plurality of filters included in the interpolation filter device, wherein the filters are arranged to perform interpolation in a same direction.

17. The motion compensation method of claim 11, wherein sharing at least one of the interpolation filter device, the pixel fetching circuit and the pixel dispatching circuit comprises:
sharing a dispatcher included in the pixel dispatching circuit by the normal mode and the RRF mode; and
utilizing the dispatcher for controlling a plurality of buffers, each coupled between a first filter and a second filter included in the interpolation filter device, to dispatch filtered pixels generated from a plurality of first filters included in the interpolation filter device to a plurality of second filters included in the interpolation filter device, respectively, wherein the first filters are arranged to perform interpolation in a same first direction, and the second filters are arranged to perform interpolation in a same second direction different from the first direction.

18. The motion compensation method of claim 11, wherein sharing at least one of the interpolation filter device, the pixel fetching circuit and the pixel dispatching circuit comprises:
sharing the pixel fetching circuit by the normal mode and the RRF mode.

19. The motion compensation method of claim 11, further comprising:
generating motion compensation pseudo-parameters to control operations of the interpolation filter device, the pixel fetching circuit and the pixel dispatching circuit in the RRF mode.

20. The motion compensation method of claim 19, wherein generating the motion compensation pseudo-parameters comprises:
receiving a motion vector and resizing-related information to generate the motion compensation pseudo-parameters.
